(19) United States
(12) Patent Application Publication
(10) Pub. No.: US 2017/0210411 A1
(43) Pub. Date: Jul. 27, 2017

(54) STEERING-FORCE ADJUSTING APPARATUS AND STEERING APPARATUS

(71) Applicant: Showa Corporation, Gyoda-shi (JP)

(72) Inventor: Akihiro KOGURE, Haga-gun (JP)

(73) Assignee: Showa Corporation, Gyoda-shi (JP)

(21) Appl. No.: 15/235,732

(22) Filed: Aug. 12, 2016

(30) Foreign Application Priority Data
Jan. 21, 2016 (JP) 2016-009599

(51) Int. Cl. B62D 5/04; F16H 37/02

(52) U.S. Cl. CPC B62D 5/0403; F16H 37/02

(57) ABSTRACT

A steering-force adjusting apparatus that is compact and that has a high reduction ratio is provided. A steering portion includes: a Sun roller that is arranged coaxially around an outer periphery of a middle steering shaft; a plurality of planetary rollers that are arranged around an outer periphery of the Sun roller and contact an outer peripheral surface of the Sun roller; a carrier that supports the plurality of planetary rollers so as to make the planetary rollers rotatable and that is fixed to the middle steering shaft; and a belt that connects the roller to a power generating portion so as to enable a torque to be transmitted to the power generating portion.

### CROSS-REFERENCE TO RELATED APPLICATION

The present application claims priority under 35 U.S.C. §119 to Japanese Patent Application No. 2016-009599, filed Jan. 21, 2016. The contents of this application are incorporated herein by reference in their entirety.

### BACKGROUND OF THE INVENTION

1. Field of the Invention

The present invention relates to a steering-force adjusting apparatus and a steering apparatus.

2. Description of the Related Art

For column-assist electric power steering apparatuses and steer-by-wire (SBW) steering apparatuses in which a mechanical steering steered angle is not limited and in which the steered angle is regulated based on steering reaction force torque, a steering-force adjusting apparatus is known which transmits power from a power generating portion to a steering shaft via a reduction gear. For example, Japanese Patent Application Laid-open Nos. 2007-112397, 2008-126751, and 2007-125911 describe steering-force adjusting apparatuses using a two-stage reduction gear.

### SUMMARY OF THE INVENTION

In recent years, vehicles have been increasingly computerized, and various electronic devices tend to be arranged around the steering apparatus. There tends to be a demand for saving space to arrange the steering apparatus. Thus, preferably, the steering-force adjusting apparatus for the steering apparatus is compact and has a high reduction ratio. This is because the high reduction ratio of the steering-force adjusting apparatus enables a reduction in the size of the power generating portion.

An object of the present invention is to provide a steering-force adjusting apparatus that transmits power from a power generating portion to a steering shaft via a reduction gear, the steering-force adjusting apparatus being compact and having a high reduction ratio.

To accomplish the object, an aspect of the invention provides a steering-force adjusting apparatus used for a steering apparatus of a vehicle, the steering-force adjusting apparatus including: a first shaft that is connected to a steering member subjected to a steering operation by a driver so as to enable a torque to be transmitted to the steering member; a tube member that is coaxially arranged around an outer periphery of the first shaft; a plurality of planetary members that are arranged around an outer periphery of the tube member and contact an outer peripheral surface of the tube member; a carrier that supports the plurality of planetary members so as to make the planetary members rotatable and that is fixed to the first shaft; a second shaft that is rotationally driven by a power generating portion; and a belt-drive power-transmission mechanism that connects the tube member to the second shaft so as to enable a torque to be transmitted to the second shaft.

This configuration allows power from the power generating portion to be transmitted to the tube member via the power transmission mechanism, providing a steering adjusting apparatus that is compact and that has a high reduction ratio.

To accomplish the above-described object, another aspect of the present invention provides a steering apparatus for a vehicle including: a steering member that is subjected to a steering operation by a driver; a steering-force adjusting apparatus that adjusts a steering force of the steering operation; and a turning member that steers wheels in accordance with the steering operation, wherein the steering-force adjusting apparatus includes: a first shaft that is connected to a steering member so as to enable a torque to be transmitted to the steering member; a tube member that is coaxially arranged around an outer periphery of the first shaft; a plurality of planetary members that are arranged around an outer periphery of the tube member and contact an outer peripheral surface of the tube member; a carrier that supports the plurality of planetary members so as to make the planetary members rotatable and that is fixed to the first shaft; a second shaft that is rotationally driven by a power generating portion; and a belt-drive power-transmission mechanism that connects the tube member to the second shaft so as to enable a torque to be transmitted to the second shaft.

The aspects of the present invention can provide a steering-force adjusting apparatus that is compact and that has a high reduction ratio.

### BRIEF DESCRIPTION OF THE DRAWINGS

FIG. 1 is a schematic diagram schematically depicting a configuration of an important part of a steering apparatus according to Embodiment 1 of the present invention;

FIG. 2 is a sectional view schematically depicting a configuration example of a steering portion according to Embodiment 1 of the present invention;

FIG. 3 is a sectional view schematically depicting a configuration example of a first reduction gear according to Embodiment 1 of the present invention;

FIGS. 4A and 4B are sectional views schematically depicting a configuration example of a second reduction gear according to Embodiment 1 of the present invention;

FIG. 5 is a sectional view schematically depicting a configuration example of a steering portion according to Embodiment 2 of the present invention;

FIG. 6 is a sectional view schematically depicting a configuration example of a steering portion according to Embodiment 3 of the present invention; and

FIG. 7 is a sectional view schematically depicting a configuration example of a second reduction gear according to Embodiment 3 of the present invention.

### DESCRIPTION OF THE PREFERRED EMBODIMENTS

### Embodiment 1

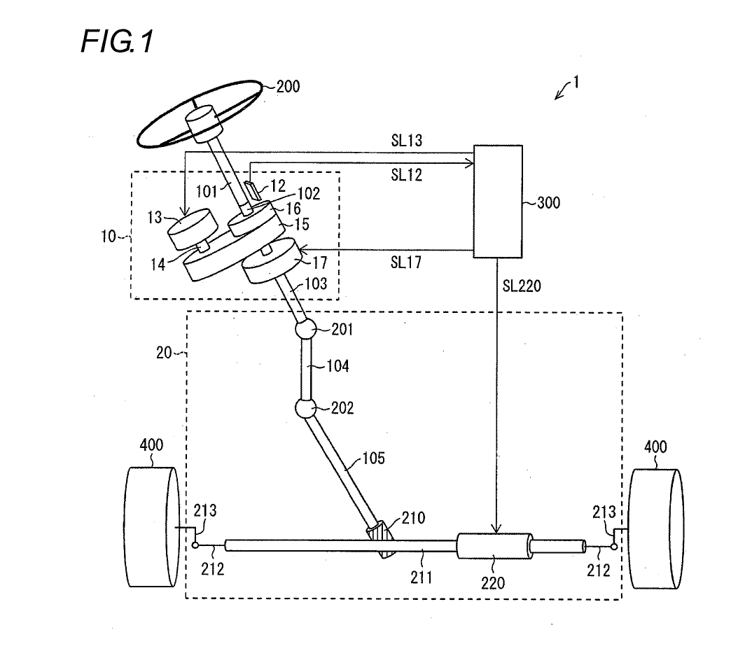

A steering apparatus 1 for a vehicle according to Embodiment 1 will be described with reference to FIG. 1.

FIG. 1 is a schematic diagram schematically depicting a configuration of an important part of the steering apparatus 1. As depicted in FIG. 1, the steering apparatus 1 includes a steering portion 10, a turning member 20, a steering member 200, and a control portion 300. The steering apparatus 1 is used to steer wheels 400 in accordance with a steering operation performed by a driver via the steering member 200.

The steering apparatus 1 is a steer-by-wire steering apparatus having at least two functions to (1) enable mechanical activation or inactivation of a torque transmission path between the steering member 200 and the turning member 20 and to (2) enable electric control of the steered angle of the wheels 400 in accordance with a steering operation via the steering member 200 while the torque transmission path is inactive.

However, the present invention is not limited to this. The steering apparatus 1 may be configured as an electric power steering apparatus having at least two functions to (3) constantly mechanically keep the torque transmission path between the steering member 200 and the turning member 20 active and to (4) apply an assist force to the steering operation performed via the steering member 200.

(Steering Portion 10)

The steering portion 10 has a function to accept the steering operation performed by the driver via the steering member 200 and a function to generate a reaction force against the steering operation and transmit the reaction force against the steering member 200. Due to the provision of the latter function, the steering portion 10 is hereinafter also referred to as a reaction-force generating apparatus or a steering-force adjusting apparatus that adjusts the steering force of the steering operation.

As depicted in FIG. 1, the steering portion 10 includes an upper steering shaft 101, a middle steering shaft (first shaft) 102, a lower steering shaft 103, a torque sensor 12, a power generating portion 13, a power transmission shaft (second shaft) 14, a first reduction gear (power transmission mechanism) 15, a second reduction gear 16, and a clutch portion 17.

The “steering shaft” as used herein refers to a shaft coaxially arranged between the steering member 200 and a first universal joint 201 described below and includes the upper steering shaft 101, the middle steering shaft 102, and the lower steering shaft 103 in FIG. 1.

An “upper end” as used herein refers to an upstream end (that is, an input end) of a transmission path for a steering force exerted in accordance with a steering operation by the driver. A “lower end” as used herein refers to a downstream end (that is, an output end) of the transmission path for the steering force (this also applies to other components).

The upper end of the upper steering shaft 101 is connected to the steering member 200 so as to enable a torque to be transmitted to the steering member 200. The phrase “connected so as to enable a torque to be transmitted” as used herein refers to connection between two members in such a manner that one of the members is rotated in conjunction with rotation of the other member. The phrase includes, for example, at least a case where the two members are integrally shaped, a case where one of the members is directly or indirectly fixed to the other member, and a case where the two members are connected together via a joint member or the like so as to be interlocked with each other.

In the present embodiment, the upper end of the upper steering shaft 101 is fixed to the steering member 200 to allow the steering member 200 and the upper steering shaft 101 to rotate integrally.

The upper steering shaft 101 and the middle steering shaft 102 are elastically connected together so as to enable a torque to be transmitted. The torque sensor 12 detects possible torsion between the upper steering shaft 101 and the middle steering shaft 102.

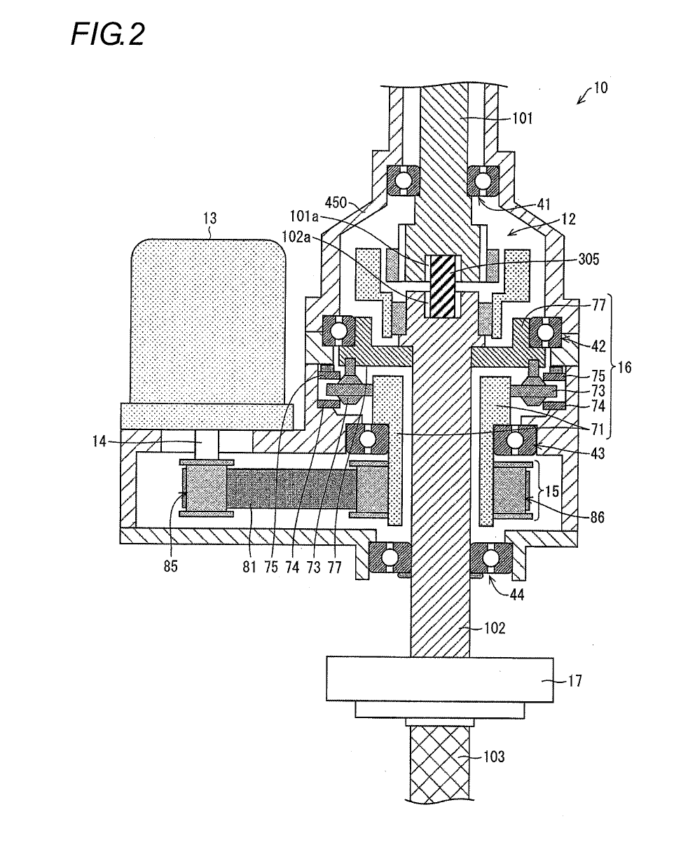

More specifically, a cavity is formed inside each of the upper steering shaft 101 and the middle steering shaft 102. A torsion bar 305 (see FIG. 2) is arranged in the cavities to elastically couple the upper steering shaft 101 and the middle steering shaft 102 together. When the driver performs a steering operation via the steering member 200, a helix angle θ_{T} corresponding to the magnitude of a torque T is defined between the upper steering shaft 101 and the middle steering shaft 102. The torque sensor 12 detects the helix angle θ_{T} and supplies a torque sensor signal SL12 indicative of a detection result to the control portion 300. The steering portion 10 may include a steering angle sensor configured to detect the steering angle of the steering member 200 and supply a signal indicative of the detected steering angle or a steering angle velocity to the control portion 300.

The second reduction gear 16 is connected to the middle steering shaft 102 to enable a torque to be transmitted to the middle steering shaft 102. The first reduction gear 15 is connected to the second reduction gear 16 to enable a torque to be transmitted to the second reduction gear 16. A lower end of the middle steering shaft 102 is connected to the clutch portion 17.

The power generating portion 13 provides a torque to the power transmission shaft 14 in accordance with a torque control signal SL13 supplied by the control portion 300.

The power generating portion 13 is, for example, a motor main body. The power transmission shaft 14 is, for example, a motor output shaft penetrating the motor main body and rotationally driven by the motor main body. Using a general-purpose electric motor as the power generating portion 13 enables manufacturing costs to be further kept low. The power transmission shaft 14 may be another shaft connected to the motor output shaft to enable a torque to be transmitted to the motor output shaft. The power transmission shaft 14 is arranged along the middle steering shaft 102. The phrase “arranged along” does not necessarily mean a complete parallel state but means in the present embodiment that the power transmission shaft 14 and the middle steering shaft 102 are arranged so as to enable the first reduction gear 15, which is a belt-drive power-transmission mechanism, to transmit power between the power transmission shaft 14 and the middle steering shaft 102.

The first reduction gear 15 is connected to the power transmission shaft 14 so as to enable a torque to be transmitted to the power transmission shaft 14.

A torque generated by the power generating portion 13 is transmitted to the middle steering shaft 102 via the power transmission shaft 14, the first reduction gear 15, and the second reduction gear 16.

The clutch portion 17 is configured to mechanically activate or inactivate a torque transmission path between the steering member 200 and the turning member 20 in a switchable manner in accordance with a clutch control signal SL17 supplied by the control portion 300. More specifically, the clutch portion 17 mechanically activates or inactivates torque transmission between a lower end of the middle steering shaft 102 and an upper end of the lower steering shaft 103 in a switchable manner in accordance with the clutch control signal SL17. A specific configuration of the clutch portion 17 does not limit the present embodiment, but the clutch portion 17 may be, for example, a dog clutch with a lock mechanism using an electromagnetic solenoid, a roller clutch, or a multi-disc clutch with a plurality of clutch plates. The clutch portion 17 may be arranged on an intermediate shaft 104 or a pinion shaft 105.

When the steering apparatus 1 is configured as an electric power steering apparatus, the steering portion 10 has a function to accept a steering operation performed by the driver via the steering member 200 and a function to generate an assist force to transmit the assist force to the steering member 200. In this case, the clutch portion 17 is not needed. Also in this case, the steering portion 10 may be referred to as a column assist mechanism for the electric power steering apparatus or a steering-force adjusting apparatus.

(Control Portion 300)

The control portion 300 controls a steered force generated by a steered-force generating portion 220 and a torque generated by the power generating portion 13 in accordance with steering operation by the driver.

More specifically, the control portion 300 references a torque sensor signal SL12 supplied by a torque sensor to generate a torque control signal SL13 that allows the torque generated by the power generating portion 13 and a steered-force control signal SL220 that allows a steered force generated by the steered-force generating portion 220. The control portion 300 then supplies the torque control signal SL13 and the steered-force control signal SL220 to the power generating portion 13 and the steered-force generating portion 220, respectively.

The control portion 300 may further reference a signal indicative of a steering angle of the steering member 200, a vehicle velocity signal from a vehicle velocity sensor, and the like to generate a torque control signal SL13 and a steered-force control signal SL220.

The control portion 300 also supplies the clutch control signal SL17 to the clutch portion 17 to control the clutch portion 17 between a connection state and a disconnection state.

When the clutch portion 17 is in the disconnection state, the control portion 300 controls the power generating portion 13 such that the power generating portion 13 generates a reaction force against a steering operation performed by the driver. More specifically, the control portion 300 controls the power generating portion 13 such that, to the steering shaft, a reaction force torque is transmitted which acts in a direction opposite to the direction in which a steering torque input by the driver via the steering member 200 acts. This gives the driver an operation feeling involved in the steering operation. Because of this, the driver is able to obtain the sense of performing steering operation.

A specific method in which the control portion 300 controls the clutch portion 17 does not limit the present embodiment. For example, the control portion 300 may be configured to switch the clutch portion 17 to the connection state when a certain abnormality occurs in the steering apparatus 1 or when an ignition is switched off. Such a configuration allows the driver to steer the wheels 400 without using an electric path, for example, when an abnormality occurs or when the ignition is switched off.

The control portion 300 may be configured to control the power generating portion 13 such that, to the steering shaft, a torque is transmitted which acts in the same direction as that in which the steering torque input by the driver via the steering member 200 acts, when the clutch portion 17 is in the connection state. Consequently, even when the clutch portion 17 is in the connection state, the driver can perform a steering operation without the need for a strong force.

(Turning Member 20)

The turning member 20 is configured to steer the wheels 400 in accordance with the driver's steering operation accepted by the steering portion 10.

As depicted in FIG. 1, the turning member 20 includes a first universal joint 201, the intermediate shaft 104, a second universal joint 202, the pinion shaft 105, a pinion gear 210, a rack shaft 211, tie rods 212, knuckle arms 213, and the steered-force generating portion 220.

An upper end of the intermediate shaft 104 is coupled to a lower end of the lower steering shaft 103 via the first universal joint 201 so as to enable a torque to be transmitted to the lower steering shaft 103.

A lower end of the intermediate shaft 104 is coupled to an upper end of the pinion shaft 105 via the second universal joint 202 so as to enable a torque to be transmitted to the pinion shaft 105.

The pinion gear 210 is connected to a lower end of the pinion shaft 105 so as to enable a torque to be transmitted to the pinion shaft 105. More specifically, the pinion gear 210 is fixed to the pinion shaft 105 such that the pinion shaft 105 and the pinion gear 210 rotate integrally.

A rack engaging with the pinion gear 210 is formed on a side of the rack shaft 211 that faces the pinion gear 210.

While the clutch portion 17 is in the connection state, the pinion gear 210 is rotated by a steering operation performed by the driver via the steering member 200, to displace the rack shaft 211 in an axial direction.

On the other hand, while the clutch portion 17 is in the disconnection state, the steered-force generating portion 220 generates a steered force in accordance with the steered-force control signal SL220 from the control portion 300 to displace the rack shaft 211 in the axial direction.

The rack shaft 211 is displaced in the axial direction to steer the wheels 400 via the tie rods 212 provided at respective opposite ends of the rack shaft 211 and the knuckle arms 213 coupled to the respective tie rods 212.

A specific configuration of the steered-force generating portion 220 does not limit the present embodiment. For example, the following configuration examples are possible.

### Configuration Example 1

The steered-force generating portion 220 includes a motor and a conversion mechanism that converts rotary motion of an output shaft of the motor into linear motion of the rack shaft 211 in the axial direction. As the conversion mechanism, what is called a ball screw mechanism may be used which includes a nut in which a helical groove is formed in an inner peripheral surface of the nut and which is rotationally driven by the motor, a helical groove formed in an outer peripheral surface of the rack shaft and having the same pitch as that of the helical groove in the nut and a plurality of rolling balls sandwiched between the helical groove in the nut and the helical groove in the rack shaft.

Moreover, the steered-force generating portion 220 may include a driving pulley connected to the output shaft of the motor arranged along the rack shaft 211 so as to enable a torque to be transmitted to the output shaft, a driven pulley connected to the nut so as to enable a torque to be transmitted to the nut, and a suspension member that is suspended between the driving pulley and the driven pulley to transmit a torque from the driving pulley to the driven pulley.

### Configuration Example 2

The steered-force generating portion 220 may include a hollow motor arranged coaxially with the rack shaft 211 to rotationally drive the nut in Configuration Example 1. Such a configuration eliminates the need for the driving pulley and the driven pulley in Configuration Example 1, allowing space to be saved.

### Configuration Example 3

The steered-force generating portion 220 may include, instead of the ball screw mechanism, a second pinion shaft rotationally driven by the motor and a pinion gear connected to the second pinion shaft so as to enable a torque to be transmitted to the second pinion shaft, the pinion gear engaging with a second rack formed on the rack shaft 211.

### Configuration Example 4

In the above-described example, the steered-force generating portion 220 is configured to transmit a steered force to the rack shaft 211. However, this does not limit the present embodiment. For example, the steered-force generating portion 220 may include a motor, a worm that is rotationally driven by the motor, and a worm wheel that meshes with the worm and that is connected to the pinion shaft 105 so as to enable a torque to be transmitted to the pinion shaft 105.

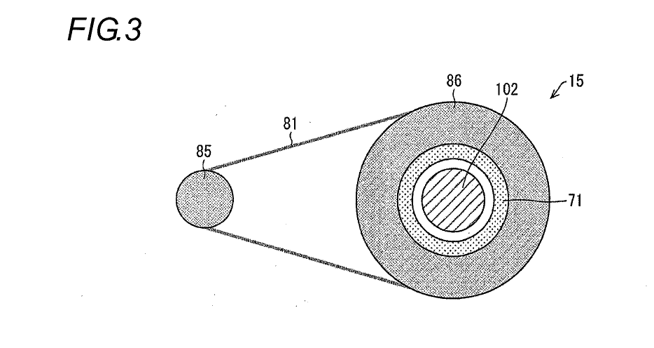

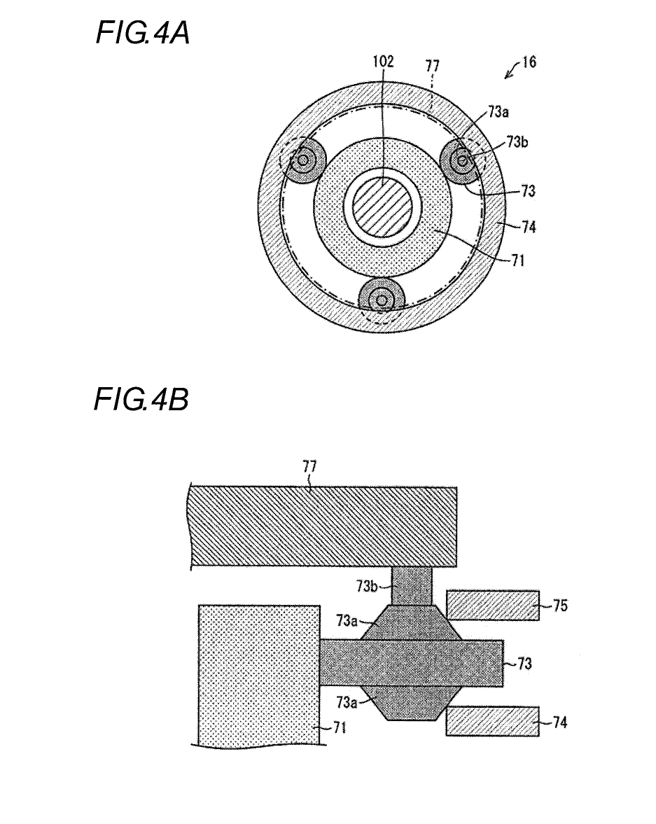

Now, with reference to FIGS. 2 to 4B, a configuration example of the steering portion 10 will be more specifically described. FIG. 2 is a sectional view schematically depicting a configuration example of the steering portion 10. FIG. 3 is a diagram schematically depicting a configuration example of the first reduction gear 15. FIGS. 4A and 4B are diagrams schematically depicting a configuration example of the second reduction gear 16.

As depicted in FIG. 2, the steering portion 10 includes a housing 450 that houses a part of the upper steering shaft 101, a part of the middle steering shaft 102, the torque sensor 12, the first reduction gear 15, and the second reduction gear 16.

A cavity 101a and a cavity 102a are formed inside the upper steering shaft 101 and the middle steering shaft 102, respectively. A torsion bar 305 is arranged in the cavity 101a and the cavity 102a to couple the upper steering shaft 101 and the middle steering shaft 102 together. The torque sensor 12 is provided around the torsion bar 305.

As depicted in FIGS. 2 and 3, the first reduction gear 15 is a belt-drive power-transmission mechanism. The “belt drive” is a method of transmitting power via a flexible belt. In the present embodiment, the first reduction gear 15 includes a driving pulley 85, a driven pulley 86, and a belt 81. The driving pulley 85 is fixed to the power transmission shaft 14 rotationally driven by the power generating portion 13, and rotates integrally with the power transmission shaft 14. The driven pulley 86 has a larger radius than the driving pulley 85 and is fixed to a Sun roller (tube member) 71 arranged coaxially around an outer periphery of the middle steering shaft 102, so as to rotate integrally with the Sun roller 71. The belt 81 is passed between the driving pulley 85 and the driven pulley 86 so as to transmit power between the driving pulley 85 and the driven pulley 86. Consequently, the first reduction gear 15 enables a reduction in vibration, noise, and the like and allows possible backlash (rotational backlash) to be avoided.

As depicted in FIGS. 2 and 4A, the second reduction gear 16 includes the Sun roller 71, a plurality of planetary rollers (planetary members) 73, a carrier 77, a first ring (ring member) 74, and a second ring (ring member) 75. The Sun roller 71 is arranged coaxially around the outer periphery of the middle steering shaft 102. The planetary rollers 73 are arranged around an outer periphery of the Sun roller 71. Each of the planetary rollers 73 is in contact with an outer peripheral surface of the Sun roller 71. The carrier 77 supports each of the planetary rollers 73 so as to make the planetary rollers 73 rotatable, and is fixed to the middle steering shaft 102.

The Sun roller 71 and each of the planetary rollers 73 frictionally transmit power to and from each other. The phrase “frictionally transmit power” refers to transmission of power based on friction drive or traction drive. The “friction drive” is a method in which power is transmitted from a driving roller to a driven roller based on a friction force exerted between the two rollers in direct pressure contact with each other. The “traction drive” is a method in which power is transmitted from a driving roller to a driven roller based on a friction force exerted via a lubricant film interposed between the two rollers in pressure contact with each other. The type of lubricant used is not limited to any particular type.

As depicted in FIGS. 4A and 4B, each planetary roller 73 includes a slope portion 73a and a shaft 73b connected to the carrier 77. Each of the planetary rollers 73 is enabled to make two types of motions including rotation around the shaft 73b (rotation on its own axis) and movement (revolution) along an outer periphery of the Sun roller 71.

As depicted in FIGS. 2 and 4B, the first ring 74 and the second ring 75 are non-rotational rings and move from an external side (a side of each planetary roller 73 that is farther from the Sun roller 71) toward the planetary roller 73 to come into abutting contact with the slope portion 73a of the planetary roller 73. The first ring 74 moves from the clutch portion 17 side toward each planetary roller 73 to come into abutting contact with the planetary roller 73. The second ring 75 moves from the steering member 200 side toward each planetary roller 73 to come into abutting contact with the planetary roller 73. The first ring 74 and the second ring 75 preferably come into point contact with the planetary roller 73 but may be come into line or surface contact with the planetary roller 73.

As described above, the first ring 74 and the second ring 75 move from the external side toward each planetary roller 73 to come into abutting contact with the planetary roller 73, allowing the planetary roller 73 to be pressed against the Sun roller 71. Consequently, power can be suitably transmitted between the planetary roller 73 and the Sun roller 71.

Each planetary roller 73, to which power is transmitted from the Sun roller 71, is rotated and revolved. The carrier 77, which supports the planetary rollers 73 and which is fixed to the middle steering shaft 102, transmits revolution of the planetary rollers 73 to the middle steering shaft 102. The middle steering shaft 102 is connected to the steering member 200 via the upper steering shaft 101 so as to enable a torque to be transmitted to the steering member 200. Thus, the middle steering shaft 102 allows a reaction force generated by the power generating portion 13 to be transmitted to the steering member 200.

A material for the Sun roller 71, the planetary rollers 73, the first ring 74, and the second ring 75 is not particularly limited. These components may be formed of, for example, metal or resin.

As depicted in FIG. 2, a bearing 41, a bearing 42, a bearing 43, and a bearing 44 are arranged to support the upper steering shaft 101, the carrier 77, the Sun roller 71, and the middle steering shaft 102 so as to allow these components to pivot with respect to the housing 450.

### Effects of the Present Embodiment

As described above, the present embodiment uses a combination of the first reduction gear 15 and the second reduction gear 16. Moreover, the second reduction gear 16 is configured to input power transmitted from the first reduction gear 15, to the Sun roller 71. This configuration allows a high reduction ratio to be achieved based on a planetary gear system, compared to a configuration using a ring gear (outer gear) as an input shaft. This allows the steering portion 10 to achieve a high reduction ratio.

Consequently, required torque can be reduced at the power generating portion 13, suitably enabling a reduction in the size of the steering apparatus 1.

In the present embodiment, the power transmission shaft 14, rotationally driven by the power generating portion 13, is connected to the Sun roller 71 by the first reduction gear 15, which is a belt-drive power-transmission mechanism, so as to enable a torque to be transmitted to the Sun roller 71. For example, compared to a configuration in which a planetary gear mechanism is used instead of the second reduction gear 16 and in which the power transmission shaft 14 is connected to an annulus gear of the planetary gear mechanism by a belt-drive power-transmission mechanism, so as to enable a torque to be transmitted to the annulus gear, the present configuration restrains the steering shaft from projecting in a radial direction, enabling a reduction in the size of the steering portion 10.

Changing settings for the driven pulley 86 allows the reduction ratio of the steering portion 10 to be changed without affecting packageability of the steering portion 10.

As described above, the present embodiment can provide a steering-force adjusting apparatus that is compact and that has a high reduction ratio.

When the second reduction gear 16 is configured to transmit power based on the friction force exerted between the Sun roller 71 and the planetary rollers 73, vibration, noise, and the like can be reduced, and backlash and torque fluctuation can be avoided.

The power generating portion 13 is arranged on an opposite side of the first reduction gear 15 to the clutch portion 17. In the example depicted in FIG. 2, the power generating portion 13 is arranged closer to the steering member 200 than the first reduction gear 15. This arrangement of the power generating portion 13 provides an arrangement space for the clutch portion 17, enabling a further reduction in the size of the steering portion 10.

### Embodiment 2

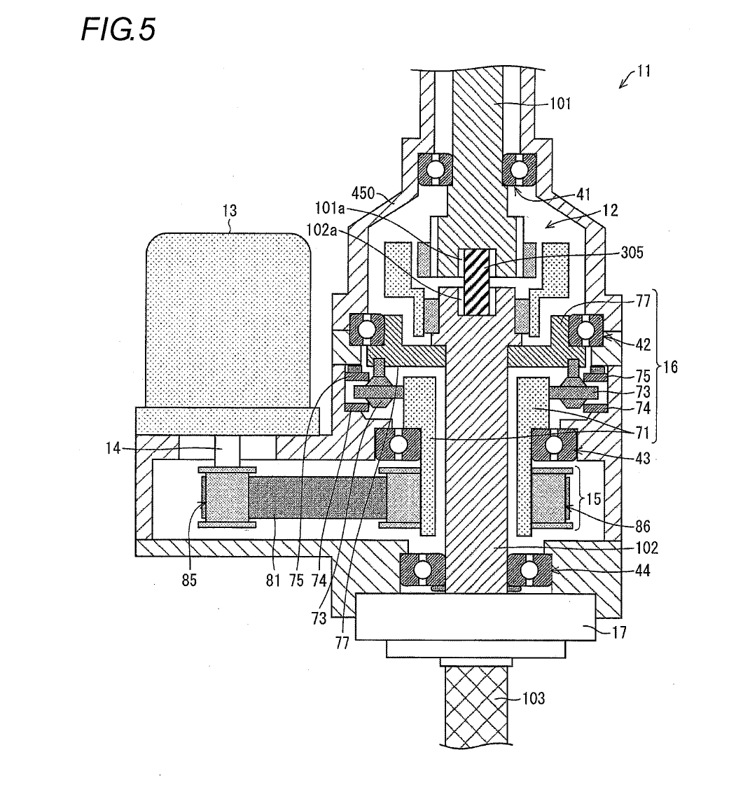

Embodiment 2 will be described with reference to FIG. 5. Members of Embodiment 2 already described herein are denoted by the same reference numerals and will not be described below. Embodiment 2 uses a steering portion 11 instead of the steering portion 10 according to Embodiment 1. The steering portion 11 is different from the steering portion 10 according to Embodiment 1 in that the clutch portion 17 is arranged in the housing 450.

FIG. 5 is a sectional view schematically depicting a configuration example of the steering portion 11. As depicted in FIG. 5, the clutch portion 17 is arranged in the housing 450. In other words, the housing 450 houses the Sun roller 71, the planetary rollers 73, the carrier 77, the first reduction gear 15, and the clutch portion 17. This configuration allows the steering portion 11 to be made compact.

### Embodiment 3

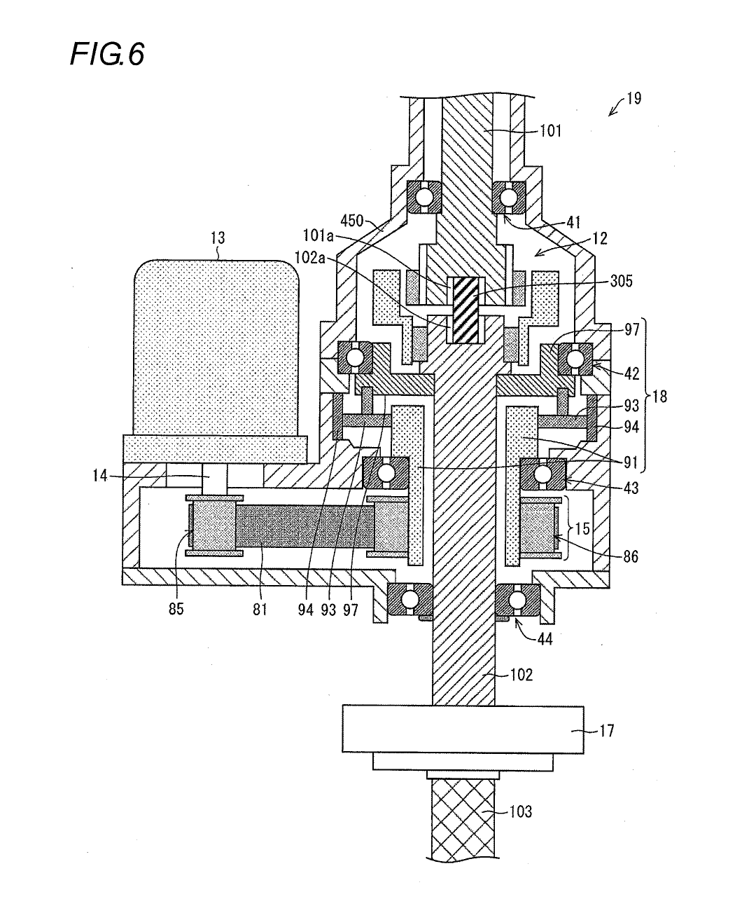

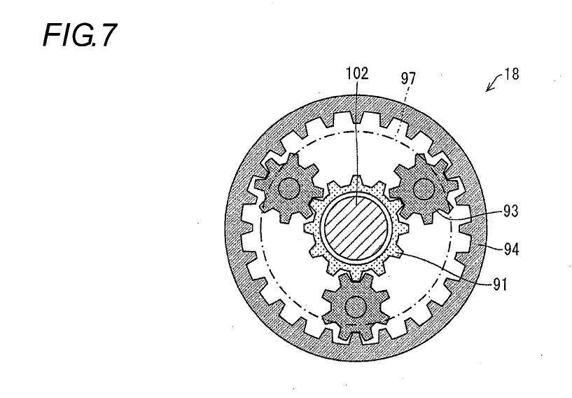

Embodiment 3 will be described with reference to FIGS. 6 and 7. Members of Embodiment 3 already described herein are denoted by the same reference numerals and will not be described below. In the above-described embodiments, the planetary roller mechanism is used as the second reduction gear. However, the present invention is not limited to this, and a planetary gear mechanism may be used as the second reduction gear. Embodiment 3 uses a steering portion 19 instead of the steering portion 10 according to Embodiment 1. The steering portion 19 is different from the steering portion 10 according to Embodiment 1 in that the steering portion 19 includes a second reduction gear 18 with a planetary gear 93 instead of the second reduction gear 16 with the planetary rollers 73.

FIG. 6 is a sectional view schematically depicting a configuration example of the steering portion 19. FIG. 7 is a diagram schematically depicting a configuration example of the second reduction gear 18.

As depicted in FIG. 6, the steering portion 19 includes the second reduction gear 18. The second reduction gear 18 includes a Sun gear 91, a planetary gear 93, a carrier 97, and an annulus gear 94.

As depicted in FIGS. 6 and 7, the Sun gear 91 is arranged coaxially around an outer periphery of the middle steering shaft 102. A plurality of planetary gears 93 is arranged around an outer periphery of the Sun gear 91. Each of the planetary gears 93 is in contact with an outer peripheral surface of the Sun gear 91 such that teeth of the planetary gear 93 mesh with teeth of the Sun gear 91. The carrier 97 supports the planetary gears 93 so as to make the planetary gears 93 rotatable, and is fixed to the middle steering shaft 102. Each of the planetary gears 93 is in contact with an inner peripheral surface of the annulus gear 94 such that teeth of the planetary gear 93 mesh with teeth of the annulus gear 94.

This configuration also uses a combination of the first reduction gear 15 and the second reduction gear 18. The second reduction gear 18 is configured to input power transmitted from the first reduction gear 15, to the Sun gear 91. Consequently, a steering-force adjusting apparatus can be provided which is compact and which has a high reduction ratio.

The present invention is not limited to the above-described embodiments. Various changes may be made to the embodiments within the scope of the claims. Embodiments resulting from appropriate combination of technical means disclosed in different embodiments are included in the technical scope of the present invention.

1. A steering-force adjusting apparatus used for a steering apparatus of a vehicle, the steering-force adjusting apparatus comprising:
a first shaft that is connected to a steering member subjected to a steering operation by a driver so as to enable a torque to be transmitted to the steering member;
a tube member that is coaxially arranged around an outer periphery of the first shaft;
a plurality of planetary members that are arranged around an outer periphery of the tube member and contact an outer peripheral surface of the tube member;
a carrier that supports the plurality of planetary members so as to make the planetary members rotatable and that is fixed to the first shaft;
a second shaft that is rotationally driven by a power generating portion; and
a belt-drive power-transmission mechanism that connects the tube member to the second shaft so as to enable a torque to be transmitted to the second shaft.

2. The steering-force adjusting apparatus according to claim 1, wherein both the tube member and each of the planetary members are rollers, and the tube member and each of the planetary members transmit power to and from each other, based on friction between the tube member and each of the planetary members.

3. The steering-force adjusting apparatus according to claim 2, further comprising a ring member that comes into abutting contact with the planetary members to press the planetary members against the tube member.

4. The steering-force adjusting apparatus according to claim 1, wherein the power transmission mechanism comprises:
a driving pulley that rotates integrally with the second shaft; and
a driven pulley that has a larger radius than the driving pulley and that rotates integrally with tube member; and
a belt that is stretched between the driving pulley and the driven pulley.

5. The steering-force adjusting apparatus according to claim 1, wherein
the steering apparatus is a steer-by-wire steering apparatus, and
the steering-force adjusting apparatus is a reaction-force generating apparatus that generates a reaction force against the steering operation.

6. The steering-force adjusting apparatus according to claim 5, further comprising:
a clutch portion that mechanically activates or inactivates, in a switchable manner, a torque transmission path between the steering member and a turning member that steers wheels; and
a housing that houses the tube member, the plurality of planetary members, the carrier, the power transmission mechanism, and the clutch portion.

7. The steering-force adjusting apparatus according to claim 1, further comprising the power generating portion,
wherein the power generating portion is arranged closer to the steering member than the power transmission mechanism.

8. A steering apparatus for a vehicle comprising:
a steering member that is subjected to a steering operation by a driver;
a steering-force adjusting apparatus that adjusts a steering force of the steering operation; and
a turning member that steers wheels in accordance with the steering operation, wherein
the steering-force adjusting apparatus comprises:
a first shaft that is connected to a steering member so as to enable a torque to be transmitted to the steering member;
a tube member that is coaxially arranged around an outer periphery of the first shaft;
a plurality of planetary members that are arranged around an outer periphery of the tube member and contact an outer peripheral surface of the tube member;
a carrier that supports the plurality of planetary members so as to make the planetary members rotatable and that is fixed to the first shaft;
a second shaft that is rotationally driven by a power generating portion; and
a belt-drive power-transmission mechanism that connects the tube member to the second shaft so as to enable a torque to be transmitted to the second shaft.
